(19) United States
(12) Patent Application Publication
(10) Pub. No.: US 2004/0105219 A1
(43) Pub. Date: Jun. 3, 2004

(54) Chassis for housing telecommunications components

(76) Inventors: Terry E. McClellan, Maple Grove, MN (US); Zakhary Bluband, Minnetonka, MN (US)

Correspondence Address: MERCHANT & GOULD PC, P.O. BOX 2903, MINNEAPOLIS, MN, 55402-0903, US

(21) Appl. No.: 10/309,765

(22) Filed: Dec. 3, 2002

(51) Int. Cl. H02B 1/00

(52) U.S. Cl. 361/600

(57) ABSTRACT

A telecommunications chassis is disclosed herein. The chassis includes a frame and a door connected to the frame. The door is pivotally movable relative to the frame between an open position and a closed position. The door is also slidable relative to the frame between a latched position and an unlatched position.

### FIELD OF THE INVENTION

The present invention relates generally to telecommunications equipment. More particularly, the present invention relates to chassis for housing telecommunications equipment.

### BACKGROUND OF THE INVENTION

To organize telecommunications systems and to provide for design flexibility and scalability, it is common for the telecommunications systems to include a plurality of telecommunications modules that are mounted within one or more chassis. The chassis typically include structures (e.g., flanges) for mounting the chassis within telecommunications racks. FIGS. 26 and 27 of U.S. Pat. No. 6,049,709, which is incorporated by reference in its entirety, disclose example prior art chassis adapted for housing telecommunications modules such as RF couplers/splitter modules.

In the telecommunications industry, cost is often an important design consideration. Features that reduce costs without negatively affecting reliability or functionality can provide important competitive advantages in the marketplace.

### SUMMARY

One aspect of the present disclosure relates to a telecommunications chassis having features for reducing costs without compromising the functionality or reliability of the chassis. Another aspect of the present disclosure relates to a chassis having integral door hinge and latching structures.

Examples of a variety of inventive aspects are set forth in the description that follows. It is to be understood that both the foregoing general description and the following detailed description are exemplary and explanatory only and are not restrictive of the broad inventive aspects disclosed herein.

### BRIEF DESCRIPTION OF THE DRAWINGS

FIG. 1 is a front, perspective view of a telecommunications chassis having features that are examples of inventive aspects in accordance with the principles of the present disclosure;

FIG. 1A is a detailed view of one hinge structure of the chassis of FIG. 1;

FIG. 1B is a detailed view of a latch hook structure of the chassis of FIG. 1;

FIG. 2 is a side view of the chassis of FIG. 1 with the chassis door pivoted to an open position;

FIG. 3 is a side view of the chassis of FIG. 1 with the chassis door pivoted to a closed but yet unlatched orientation;

FIG. 3A is a detailed view of the latch region of FIG. 3;

FIG. 3B is a detailed view of the hinge region of FIG. 3;

FIG. 4 illustrates the chassis of FIG. 2 with the chassis door positioned in a closed and latched orientation;

FIG. 4A is a detailed view of the latch region of FIG. 4;

FIG. 4B is a detailed view of the hinge region of FIG. 4; and

FIG. 5 shows the chassis of FIG. 1 with a designation card clipped to the chassis door.

### DETAILED DESCRIPTION

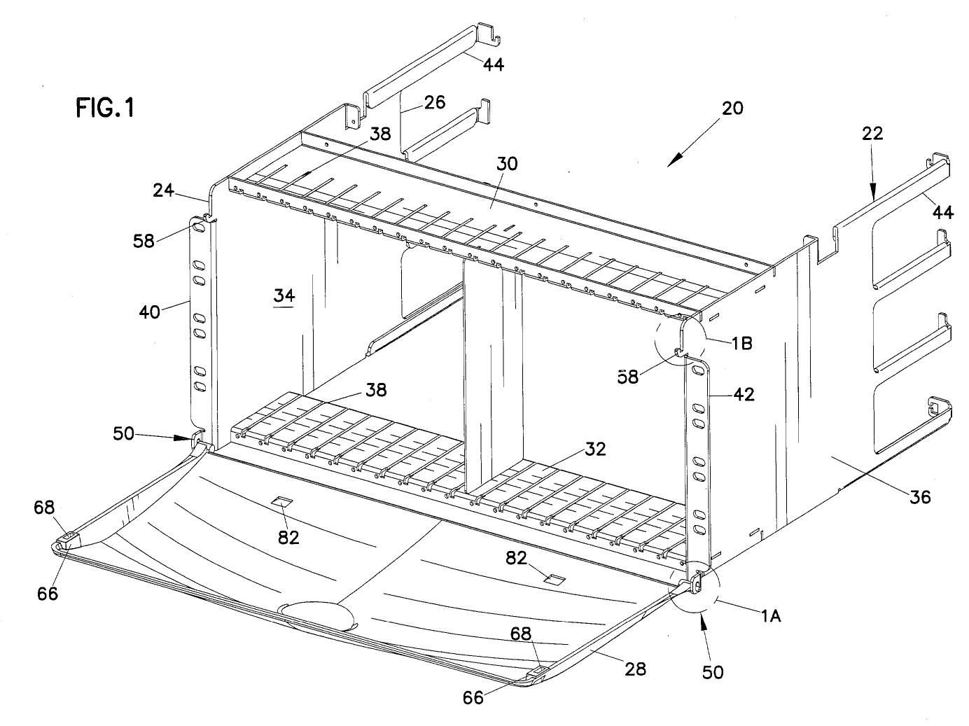

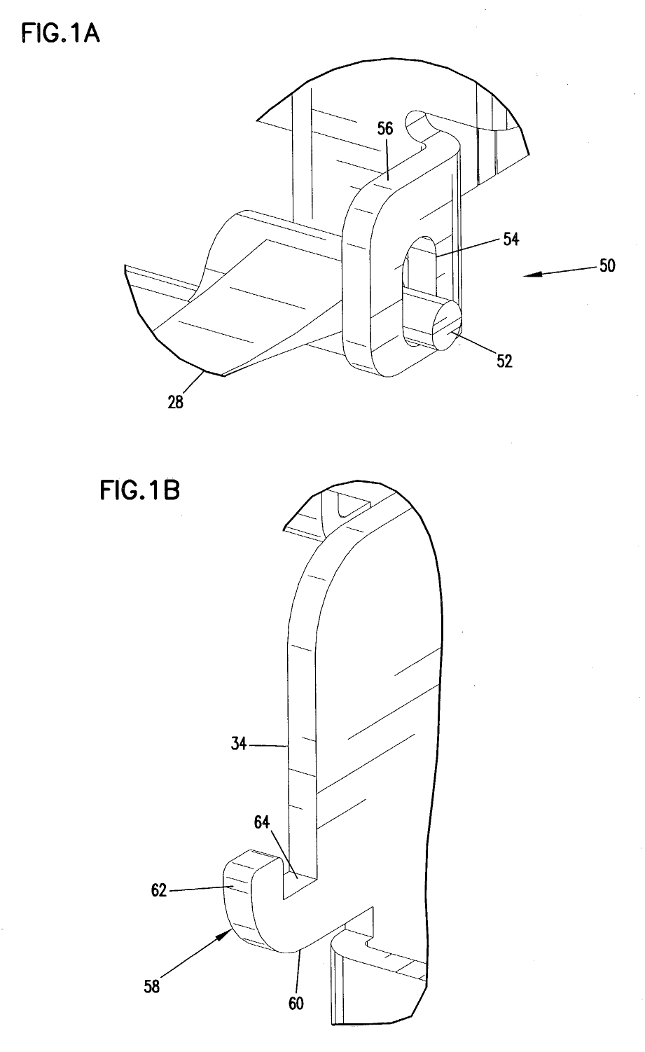

FIG. 1 illustrates a telecommunications chassis 20 having features that are examples of inventive aspects in accordance with the principles of the present disclosure. The chassis 20 includes a chassis frame 22 having a front end 24 and a back end 26. The telecommunications chassis 20 also includes a chassis door 28 pivotally connected to the front end 24 of the chassis frame 22.

The chassis frame 22 forms a generally rectangular housing adapted for holding a plurality of telecommunications modules. In a non-limiting embodiment, the frame is made of a material such as bent sheet-metal. The frame 22 includes top and bottom walls 30 and 32 that extend between left and right walls 34 and 36. The top and bottom walls define opposing slots 38 adapted for slidably receiving individual pieces of telecommunications equipment such as telecommunications modules. For example, the slots can be adapted for receiving telecommunications modules such as the RF splitter/coupler modules of U.S. Pat. No. 6,049,709. Alternatively, splitter/coupler modules of the type disclosed in U.S. patent application Ser. No. 09/780,585 entitled Plug Connector for Cable Television Network and Method of Use, filed Feb. 9, 2001 which is hereby incorporated by reference in its entirety, could also be mounted within the chassis 20. Of course, it will be appreciated that the various aspects of the present disclosure are applicable to housings for holding components of a fiber system, components of a copper system, or any other type of telecommunications equipment. Thus, it will be appreciated that numerous different types of mounting configurations could be used depending upon the type of equipment desired to be mounted within the chassis.

Referring still to FIG. 1, the chassis includes left and right mounting flanges 40 and 42. The mounting flanges 40, 42 are positioned at the front end 24 of the chassis frame 22, and project transversely outward from the left and right sides 34, 36, respectively. The chassis 20 also includes cable management slots 44 defined adjacent the back end 26 of the chassis frame 22. Further details regarding the cable management slots 44 can be found in U.S. application Ser. No. 10/117,306, entitled Cable Management Apparatus, filed Apr. 5, 2002, which is hereby incorporated by reference in its entirety.

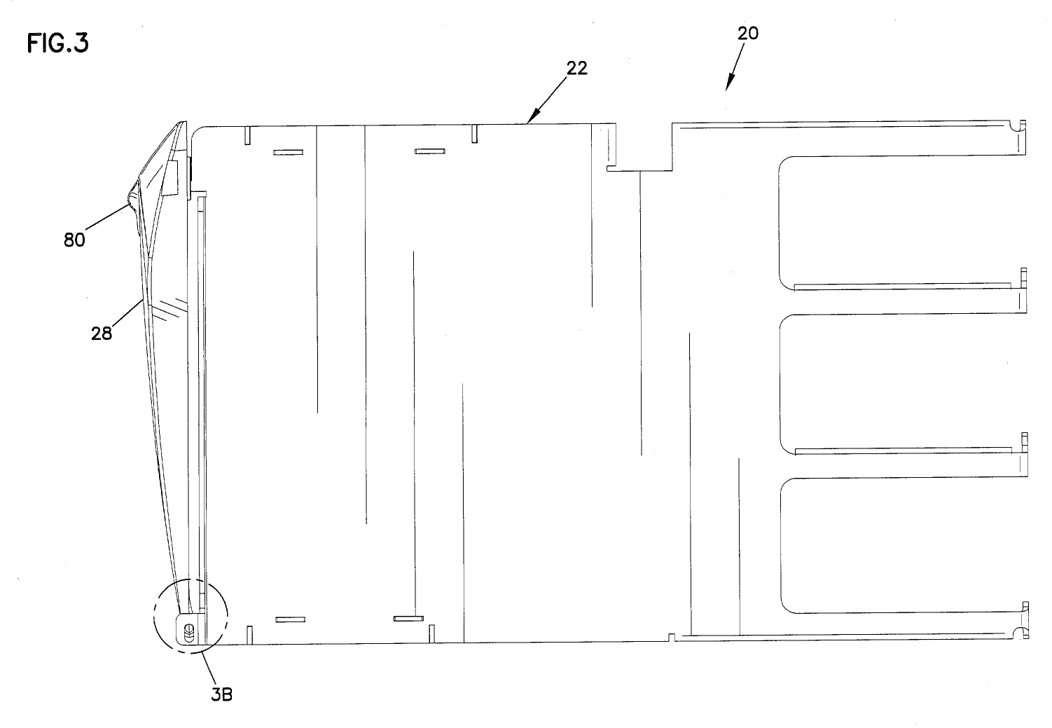

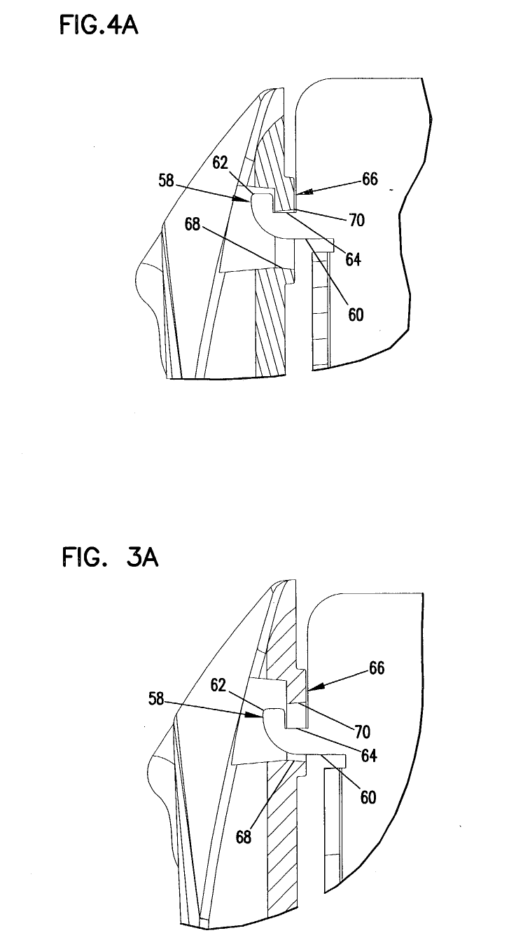

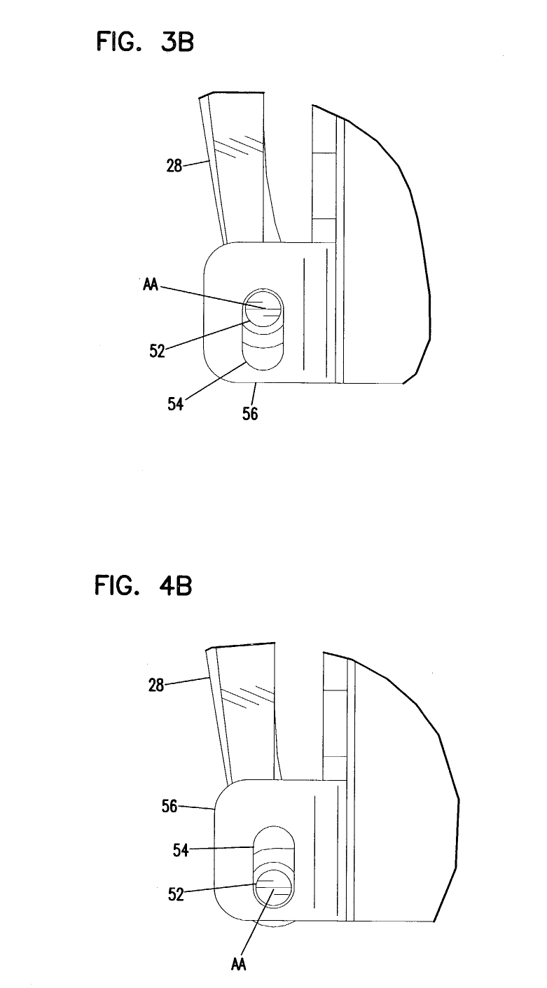

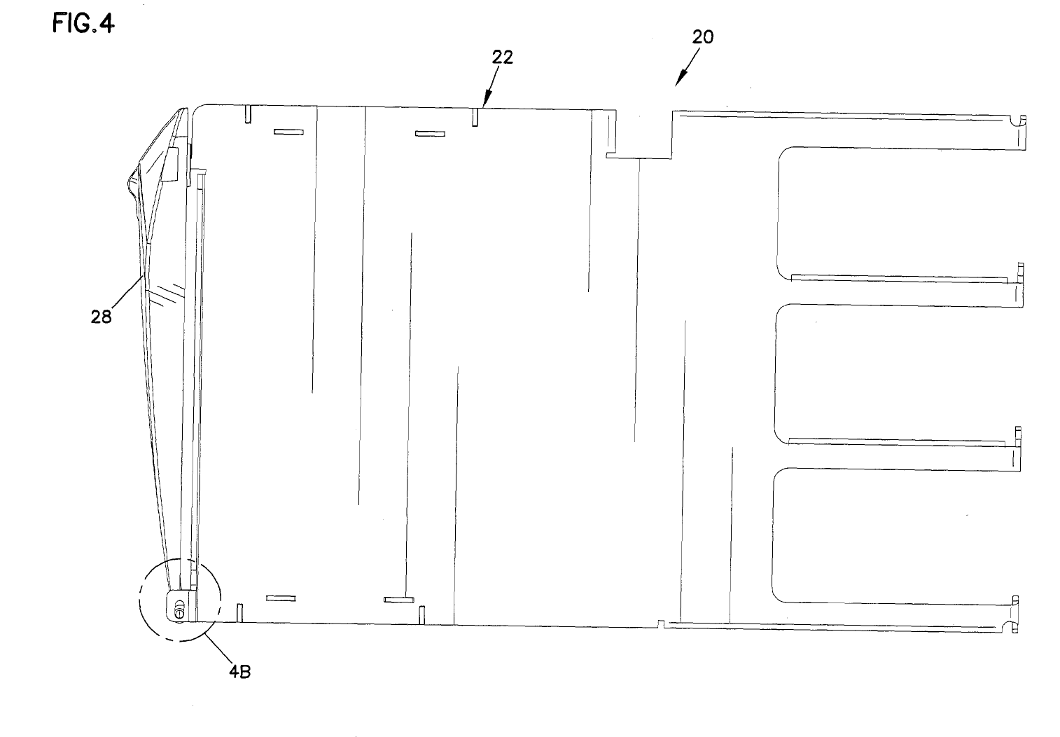

Referring still to FIG. 1, the chassis door 28 is pivotally connected to the chassis frame 22 by pivot hinges 50 located at the lower left and right front corners of the chassis frame 22. As best shown in FIG. 1A, each pivot hinge 50 includes a pivot pin 52 received within a pivot slot 54. In the depicted embodiment, the pivot pins 52 are integral parts of the chassis door 28, and the pivot slots 54 are defined within tabs 56 that are an integral part of the chassis frame 22. As shown in FIG. 1, the tabs 56 are located at the lower left and right front corners of the chassis frame 22, and project forwardly from the front end 24 of the chassis frame 22. In a preferred embodiment, the pivot slots 54 are elongated in a generally vertical direction as best shown in FIG. 1A. As described below, the elongation of the slots 54 allows the chassis door 28 to be slid or translated relative to the chassis frame 22 such that the chassis door 28 can be moved between a latched position (shown in FIG. 4) and an unlatched position (shown in FIG. 3).

In the depicted embodiment, the pivot pins 52 are integral with the chassis door 28, and the tabs 56 defining the slots 54 are integral with the chassis frame 22. It will be appreciated that in alternative embodiments, the slot and pins can be reversed such that slots or similar structures are provided on the chassis door 28, and pins or similar structures are provided on the chassis frame 22. As used herein, the term “integral” means that a part is unitarily or monolithically connected to another component. A first part that is “integral” with a second part does not need to be connected to the second part by separate fastening structures such as bolts, screws or adhesive.

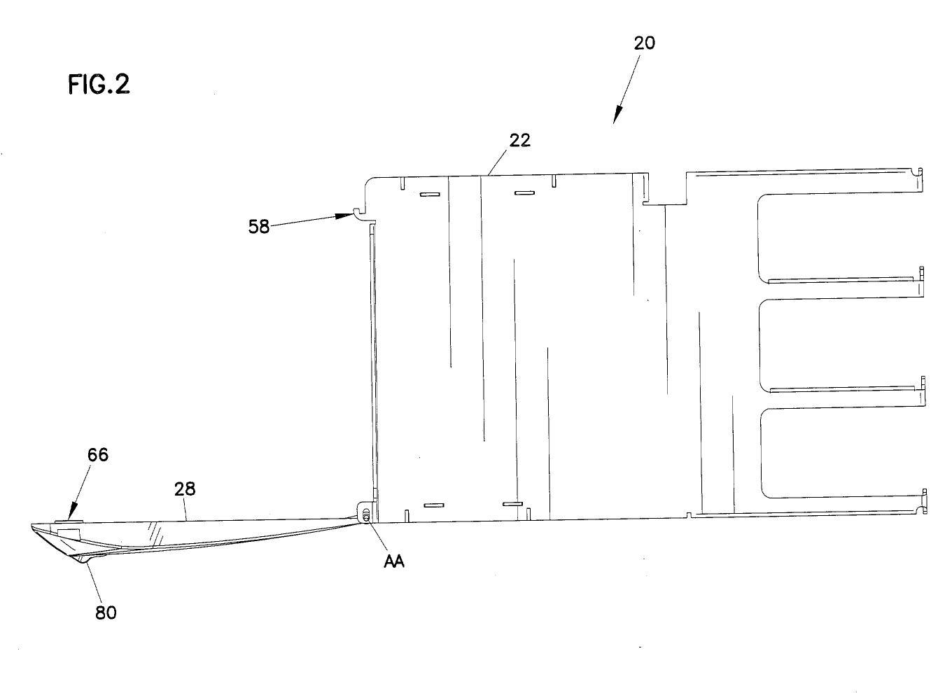

The pivot hinge 50 allows the chassis door 28 to be pivoted from an open position (shown in FIGS. 1 and 2) to a closed position (shown in FIGS. 3 and 4). In the embodiment of FIGS. 1-4, the chassis 20 includes an integral latching arrangement for holding or retaining the chassis door 28 in the closed position. Referring to FIG. 1, the latching arrangement includes left and right latch hooks 58 that are respectively integral with the left and right side walls 34, 36 of the chassis frame 22. As shown in FIG. 1B, each of the latch hooks 58 includes a base portion 60 that projects forwardly from the respective side wall 34, 36, and a retaining portion 62 that projects upwardly from the corresponding base portion 60. The latch hooks 58 define notches 64 located between the retaining portions 62 and the respective side walls 34, 36 of the chassis frame 22.

The latching arrangement of the chassis 20 also includes structures that cooperate with the latch hooks 58 to hold the chassis door 28 in the closed position. For example, referring to FIG. 1, left and right latch hook catches 66 are integrally formed with the back side of the chassis door 28 adjacent the outer corners of the chassis door 28. The latch hook catches 66 define openings 68 adapted for receiving the latch hooks 58 when the chassis door 28 is pivoted to the closed position. The latch hook openings 68 are preferably elongated in a direction corresponding to a height of the chassis door 28, and in the depicted embodiment have a length at least equal to the corresponding length of the slots 54 of the pivot hinges 50. The latch hook catches 66 also include downwardly extending catch members 70 located above the openings 68 (see FIGS. 3A and 4A). The catch members 70 are adapted to fit within the notches 64 of the latch hooks 58 to latch the chassis door 28 in the closed position (see FIG. 4A).

In use, the chassis door 28 is moved from the open position to the closed position by manually pivoting the chassis door 28 in an upward direction about a pivot axis AA (see FIGS. 2, 3B and 4B) defined by the pivot pins 52. As the chassis door 28 is pivoted upwardly, the pivot pins 58 pivot within the slots 54 of the pivot hinges 50. Once the chassis door 28 has been pivoted upwardly to a position where the latch hook catches 66 are positioned adjacent to the latch hooks 58, the chassis door 28 is manually lifted upwardly relative to the chassis frame 22. As the chassis door 28 is lifted, the pivot pins 52 slide upwardly within the slots 54 of the chassis frame 22 from the position of FIG. 4B to the position of FIG. 3B. Preferably the chassis door 28 is lifted high enough for the catch members 70 of the latch hook catches 66 to clear the retaining portions 62 of the latch hooks 58. Within the chassis door 28 lifted, the chassis door 28 can be pivoted to a fully closed positioned as shown in FIGS. 3 and 3A. Thereafter, the chassis door 28 is slid downwardly from the lifted position of FIGS. 3, 3A and 3B to a latched position as shown in FIGS. 4, 4A and 4B. When in the latched position, the catch members 70 of the latch hook catches 66 fit within the notches 64 of the latch hooks 58. As so positioned, the catch members 70 oppose the retaining portions 62 of the latch hooks 58 to prevent the chassis door 28 from unintentionally opening.

To open the chassis door 28 once latched, the door is lifted from the position of FIGS. 4, 4A and 4B to the position of FIGS. 3, 3A and 3B. After the door 28 has been lifted, the door 28 can be pivoted downwardly to the position of FIG. 2 without encountering interference from the latch hooks 58.

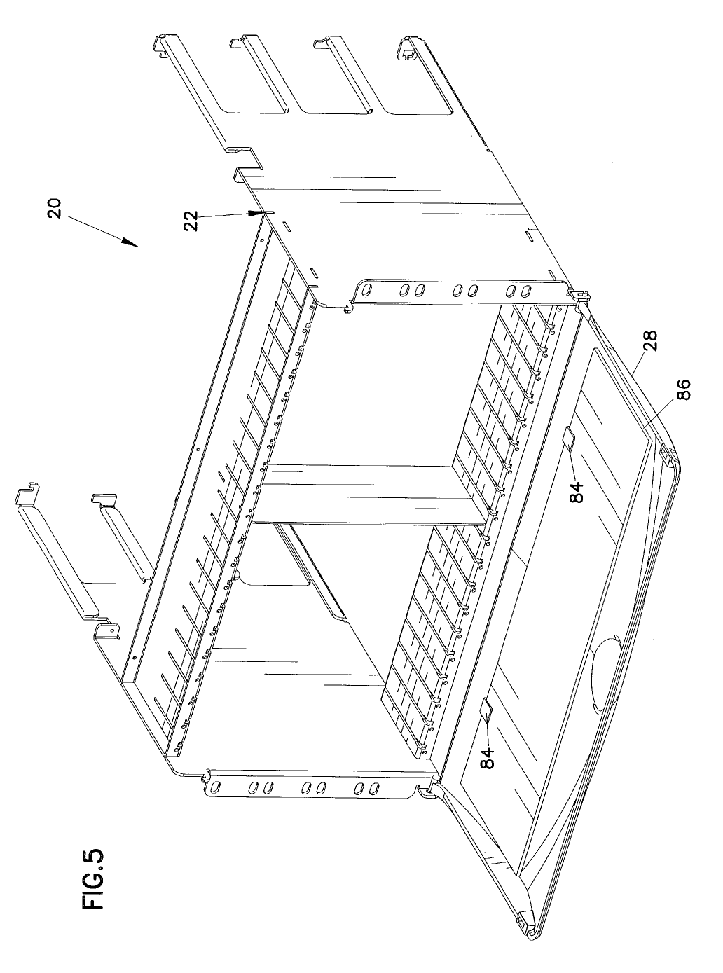

In a preferred embodiment, the chassis door 28 is made of molded plastic. To reduce the number of parts, a handle 80 is preferably integrally molded at the front side of the chassis door 28. Also, recesses 82 are preferably integrally molded at a back side of the chassis door 28. As shown in FIG. 5, the recesses 82 are adapted for receiving clips 84 for securing a designation card 86 to the back side of the chassis door 28. Other types of clip locators/clip mounting structures could also be integrally formed with the door.

In alternative embodiments, either the latch hooks or the latch hook catches 66 can include ramped surfaces for generating a camming action to lift the latch hook catches 66 over the latch hooks 58 when the chassis door 28 is closed. Examples of various inventive aspects of the present disclosure have been described herein. It will be appreciated that modifications and equivalents of the disclosed inventive aspects are intended to be included within the broad scope of the present disclosure.

We claim:

1. A telecommunications chassis comprising:
a chassis frame; and
a chassis door connected to the chassis frame, the chassis door being pivotally moveable relative to the frame between an open position and a closed position, and the chassis door being slidable relative to the frame between a latched position and an unlatched position.

2. The chassis of claim 1, wherein the chassis door is connected to the chassis frame by a pivot hinge.

3. The chassis of claim 2, wherein the pivot hinge includes a pivot pin received within a slot.

4. The chassis of claim 3, wherein the pivot pin is integral with the chassis door, and the slot is defined by the chassis frame.

5. The chassis of claim 4, wherein the slot is elongated in a vertical direction.

6. The chassis of claim 1, further comprising a handle integrally formed with a front side of the chassis door.

7. The chassis of claim 1, further comprising a clip locater integrally molded with a back side of the chassis door.

8. The chassis of claim 1, wherein one of the chassis frame and the door includes an integral latch hook, and the other of the chassis frame and the chassis door includes a latch hook catch.

9. The chassis of claim 8, wherein the latch hook is integral with the chassis frame and the latch hook catch is integral with the chassis door.

10. A telecommunications chassis comprising:
a chassis frame;
a door connected to the chassis frame at a pivot hinge that allows the door to be pivoted between an open position and a closed position, the pivot hinge including a pivot pin received within a slot, the pivot pin and the slot being slidable relative to one another to allow the door to be slid relative to the frame; and
a latching arrangement for latching the chassis door in a closed position, the latching arrangement including a first latch element connected to the door and a second latch element connected to the chassis frame, the chassis door being latched by: i) sliding the chassis door upwardly relative to the chassis frame such that the second latch element is positioned higher than the first latch element; ii) pivoting the chassis door closed while the chassis door has been slid upwardly such that the second latch element passes over the first latch element; and iii) sliding the door downwardly after the second latch element has passed over the first latch element such that the second element is caught behind the first latch element.

11. The chassis of claim 10, wherein the first latch element is a latch hook catch, and the second latch element is a latch hook.

12. The chassis of claim 10, wherein the pivot pin is integral with the chassis door and the slot is defined by the chassis frame.

13. The chassis of claim 10, wherein the chassis door is plastic, wherein a handle is formed integrally at a front side of the door, and wherein clip locator recesses are formed integrally at a back side of the chassis door.

14. A telecommunications chassis comprising:
a metal chassis frame having a front side adapted for receiving telecommunications components;
a plastic door connected to the front side of the chassis frame at a pivot hinge that allows the door to be pivoted between an open position and a closed position, the pivot hinge including a pivot pin received within a slot, the pivot pin and the slot being slidable relative to one another to allow the door to be slid relative to the frame, the plastic door having an integrally formed handle; and
a latching arrangement for latching the chassis door in a closed position, the latching arrangement including a first latch element integral with the door and a second latch element integral with the chassis frame, the chassis door being latched by: i) sliding the chassis door upwardly relative to the chassis frame such that the second latch element is positioned higher than the first latch element; ii) pivoting the chassis door closed while the chassis door has been slid upwardly such that the second latch element passes over the first latch element; and iii) sliding the door downwardly after the second latch element has passed over the first latch element such that the second element is caught behind the first latch element.
